(19) United States
(12) Patent Application Publication
(10) Pub. No.: US 2006/0153557 A1
(43) Pub. Date: Jul. 13, 2006

(54) Viewfinder

(75) Inventor: Isamu Hirai, Tokyo (JP)

Correspondence Address: GREENBLUM & BERNSTEIN, P.L.C., 1950 ROLAND CLARKE PLACE, RESTON, VA, 20191, US

(73) Assignee: PENTAX Corporation, Tokyo (JP)

(21) Appl. No.: 11/329,089

(22) Filed: Jan. 11, 2006

(30) Foreign Application Priority Data
Jan. 13, 2005 (JP) 2005-6333

(51) Int. Cl. G03B 13/24

(52) U.S. Cl. 396/150

(57) ABSTRACT

A viewfinder includes a focusing screen, an optical system having a ridge which is formed by cementing a pair of reflecting surfaces to each other; and an eyepiece, wherein an object image which is formed on the focusing screen is viewed through the eyepiece via the optical system. The ridge is provided at a position in which a line projecting the ridge on the focusing screen is shifted from a central position of the focusing screen so that a light ray which travels on an optical axis passing through a center of the focusing screen is incident on one of pair of reflecting surfaces and is not incident on the ridge.

### BACKGROUND OF THE INVENTION

1. Field of the Invention

The present invention relates to a viewfinder of an optical apparatus using a pentagonal prism or a pentagonal mirror.

2. Description of the Prior Art

A pentagonal prism or a pentagonal mirror (hollow pentagonal mirror) is used as an element of a viewfinder of an optical apparatus such as a viewfinder of a single-lens reflex camera (see Japanese Unexamined Patent Publication No. 2000-221568). This type of viewfinder is configured so that an object image focused on a focusing screen is viewed as an erect image through a pentagonal prism (or a pentagonal mirror) and an eyepiece (magnifying lens).

Since the roof portion (roof-angle portion) of a pentagonal prism (or a pentagonal mirror) is positioned relatively in the vicinity of a focusing screen that is to be viewed by the user, sometimes an eye of an user who looks into the viewfinder is focused on a point in the vicinity of the ridge of the roof portion (a boundary between the pair of roof surfaces) in the focus adjusting process of the user's eye, and accordingly the ridge of the roof portion becomes noticeable. The ridge of the roof portion is positioned in the vicinity of an optical axis of a viewfinder optical system, and lies in a plane passing through, and extending perpendicular to, the center of the focusing screen. Therefore, during an operation such as a focus adjusting operation or a spot measuring operation in which the user's eye tends to be fixed to the center of the field-of-view of the viewfinder, the ridge of the roof portion tends to be noticeable (visible).

### SUMMARY OF THE INVENTION

The present invention has been devised in view of aforementioned problem in a conventional pentagonal prism or mirror, and provides a viewfinder in which the ridge of a pentagonal prism or mirror is invisible to the viewer.

The present invention has been devised from the fact that the ridge of the pentagonal prism (or a pentagonal mirror) becomes unnoticeable if the ridge does not overlap an object image formed at the center of the field-of-view of the viewfinder. Furthermore, since the blind spot of the human eye is located at a point slightly deviated from the optical axis of the crystalline lens, the prevent invention has been devised based on the findings that the ridge becomes unnoticeable even if the ridge comes into focus if an image of the ridge is incident on the blind spot of the human eye.

According to an aspect of the present invention, a viewfinder is provided, including a focusing screen, an optical system having a ridge which is formed by cementing a pair of reflecting surfaces to each other; and an eyepiece, wherein an object image which is formed on the focusing screen is viewed through the eyepiece via the optical system. The ridge is provided at a position in which a line projecting the ridge on the focusing screen is shifted from a central position of the focusing screen so that a light ray which travels on an optical axis passing through a center of the focusing screen is incident on one of pair of reflecting surfaces and is not incident on the ridge.

It is desirable for the position of the ridge to be determined so that the light ray is incident on one of pair of reflecting surfaces to be reflected thereby and is subsequently incident on the other of pair of reflecting surfaces.

It is desirable for a roof portion of the optical system, which includes the pair of reflecting surfaces, is formed so that one of the pair of reflecting surfaces, on which the light ray is firstly incident, is elongated in the lateral direction to be greater in area than the other of the pair of reflecting surfaces, so that the other of the pair of reflecting surfaces is shortened in the lateral direction to be smaller in area than one of the pair of reflecting surfaces.

It is desirable for the position of the eyepiece to be determined so that a visual axis, of a viewer who views the center of the focusing screen through the eyepiece, does not pass the ridge.

It is desirable for the light ray, which travels on the optical axis that passes through the center of the focusing screen, travels on an optical axis of the eyepiece.

It is desirable for the optical system to be formed so that light of the object image which is reflected by the ridge is incident on a blind spot of a viewer who views the object image through the eyepiece.

It is desirable for the viewfinder to be incorporated in a single-lens reflex camera.

The optical system can be a pentagonal optical element, and wherein the pair of reflecting surfaces can be two roof surfaces of the pentagonal optical element

The pentagonal optical element can be one of a pentagonal prism and a hollow pentagonal mirror.

In an embodiment, a viewfinder is provided, including a focusing screen, an optical system; and an eyepiece, wherein an object image formed on the focusing screen is viewed through the optical system and the eyepiece. The optical system is positioned relative to the focusing screen so that a center of the focusing screen and a ridge between a pair of reflecting surfaces of the optical system do not lie in a common plane orthogonal to a plane in which the focusing screen lies.

According to the present invention, since the optical axis which connects the photographing lens and the eyepiece(eyepiece) to each other does not pass through the ridge of the roof portion of the pentagonal prism or mirror, an image of the ridge does not occur at the center of the field-of-view of the viewfinder, and accordingly, the ridge is unobtrusive even during a viewing operation via the viewfinder, especially during an operation such as a focus adjusting operation in which an eye of the user tends to be fixed on the center of the field-of-view of the viewfinder.

The present disclosure relates to subject matter contained in Japanese Patent Application No. 2005-006333 (filed on Jan. 13, 2005) which is expressly incorporated herein in its entirety.

### BRIEF DESCRIPTION OF THE DRAWINGS

The present invention will be discussed below in detail with reference to the accompanying drawings, in which:

FIG. 1 is a perspective view of optical elements of a first embodiment of a viewfinder of a single-lens reflex camera to which the present invention is applied;

FIG. 2 is a developed view of the first embodiment of the viewfinder shown in FIG. 1 which is modified to be suitable for being viewed by the right eye;

FIG. 3 is a developed view of the first embodiment of the viewfinder shown in FIG. 1 which is modified to be suitable for being viewed by the left eye;

FIG. 4A is a diagram of a conventional pentagonal prism viewed from the exit surface side;

FIG. 4B is diagram of a second embodiment of a pentagonal prism according to the present invention, viewed from the exit surface side;

FIG. 4C is a diagram of a third embodiment of the pentagonal prism according to the present invention, viewed from the exit surface side;

FIG. 4D is a diagram of a fourth embodiment of the pentagonal prism according to the present invention, viewed from the exit surface side;

FIG. 4E is a diagram of a fifth embodiment of the pentagonal prism according to the present invention, viewed from the exit surface side; and

FIG. 5 is a perspective view of optical elements of a conventional viewfinder of a single-lens reflex camera.

### DESCRIPTION OF THE PREFERRED EMBODIMENTS

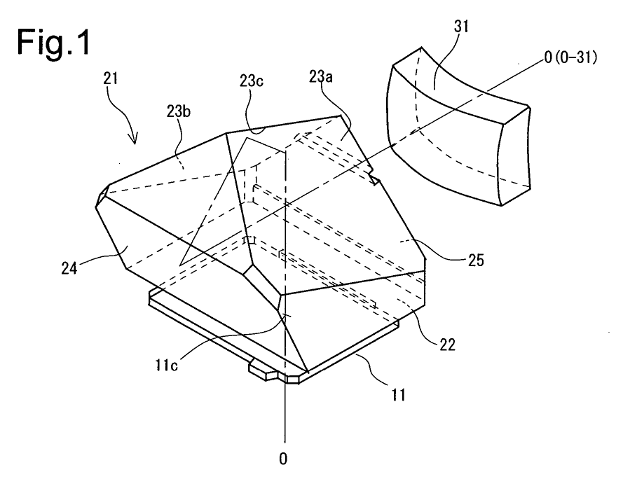

FIG. 1 is a perspective view of a first embodiment of optical elements of a viewfinder incorporated in a single-lens reflex camera to which the present invention is applied. Although the present embodiment of the viewfinder uses a pentagonal prism (pentagonal optical element), the present invention can also be applied to another type of viewfinder using a pentagonal mirror (pentagonal optical element).

Although not shown in the drawings, a light bundle of an object which is incident on a photographic lens and reflected by a quick-return mirror is formed on a focusing screen 11 as an object image. Light of the object image formed on the focusing screen 11 passes through the focusing screen 11 to be incident on an incident end surface 22 of a pentagonal prism (pentagonal optical element) 21, and subsequently, is reflected by a pair of roof surfaces (first and second reflecting surfaces) 23a and 23b or a ridge 23c therebetween, and is further reflected by a third reflecting surface 24 to subsequently exit out of the pentagonal prism 21 through an exit surface 25. Thereafter, a major part of the light which exits out of the exit surface 25 passes through an eyepiece (magnifying lens) 31 positioned in the vicinity of the exit surface 25. The photographer (user) views an object image focused on the focusing screen 11 through the eyepiece 31.

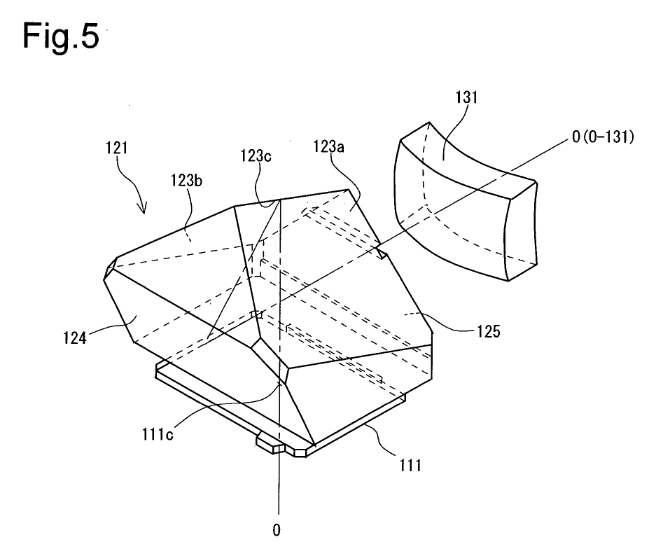

In the conventional viewfinder shown in FIG. 5 which uses a conventional pentagonal prism 121, a light ray which travels on an optical axis O (of a photographic lens) passing through a center 111c of a focusing screen 111 is reflected by a ridge 123c, which serves as a boundary between a pair of roof surfaces 123a and 123b of the pentagonal prism 121, and is further reflected by a third reflecting surface 124 to exit from an exit surface 125 of the pentagonal prism 121 toward a eyepiece 131 while traveling on an optical axis O-131 of the eyepiece 131.

Unlike such a conventional viewfinder, the pentagonal prism 21 of the viewfinder according to the present invention has been shifted in a lateral direction thereof, with respect to the corresponding position of the pentagonal prism of a conventional view finder, so that a light ray which travels on an optical axis O (of a photographic lens) passing through a center 11c of the focusing screen 11 is incident not on the ridge 23c but on one of the pair of roof surfaces 23a and 23b (the roof surface 23a in the embodiments of the present invention) to be reflected thereby toward the other roof surface 23b, and this reflected light ray, which is reflected by the roof surface 23a toward the other roof surface 23b, is reflected by the other roof surface 23b and subsequently reflected by the third reflecting surface 24 to subsequently exit from the exit surface 25 of the pentagonal prism 21 toward the eyepiece 31 while traveling on an optical axis O-31 of the eyepiece 31. Furthermore, the eyepiece 31 is positioned so that a visual axis of a viewer who views the center of the focusing screen through the eyepiece 31 does not pass through the ridge 23c.

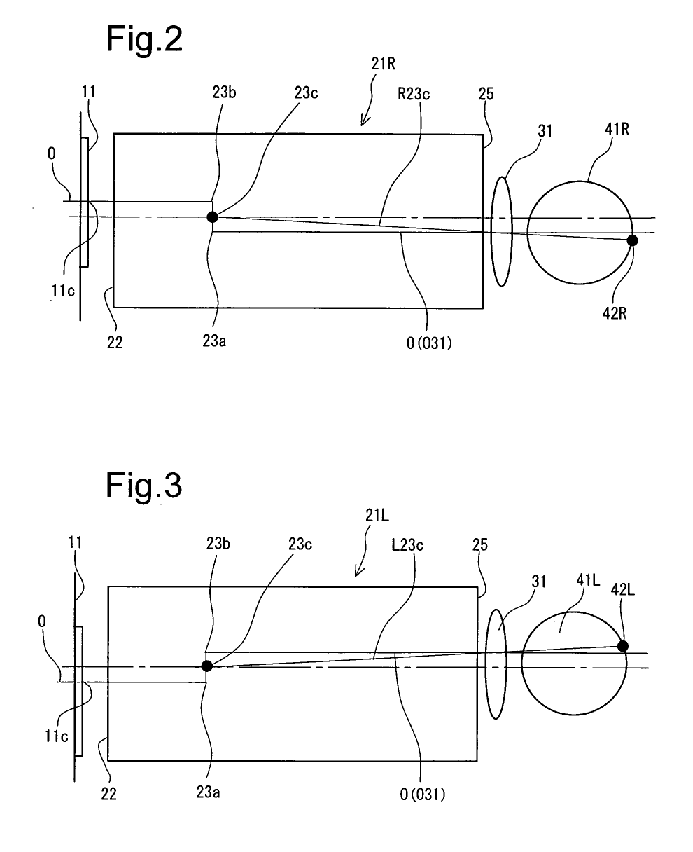

FIGS. 2 and 3 each show the positional relationship between the direction of which the pentagonal prism 21 has been shifted and an optical path thereof. FIG. 2 shows a modified embodiment of the first embodiment of the viewfinder shown in FIG. 1 viewed from above, modified to be suitable for being viewed by the right eye. FIG. 3 shows a modified embodiment of the first embodiment of the viewfinder shown in FIG. 1 viewed from above, modified to be suitable for being viewed by the left eye.

In the viewfinder constructed for the right eye shown in FIG. 2, a pentagonal prism (pentagonal optical element) 21R is provided at a position shifted leftward (downward as viewed in FIG. 2) relative to the center 11c of the focusing screen 11. Due to this arrangement, a light ray which travels on the optical axis O that passes through the center 11c of the focusing screen 11 enters the pentagonal prism 21 through the incident end surface 22 thereof to be incident on the roof surface 23b. Subsequently, the light ray incident on the roof surface 23b is reflected thereby toward the other roof surface 23a, and is reflected thereby toward the third reflecting surface 24. Subsequently, the light ray reflected by the roof surface 23b toward the third reflecting surface 24 is reflected by the third reflecting surface 24 toward the exit surface 25, and exits out of the exit surface 25 to be eventually incident on a right eye 41R of the viewer through the eyepiece 31.

In the viewfinder constructed for the left eye shown in FIG. 3, a pentagonal prism (pentagonal optical element) 21L is provided at a position shifted rightward (upward as viewed in FIG. 2) relative to the center 11c of the focusing screen 11. Due to this arrangement, a light ray which travels on the optical axis O that passes through the center 11c of the focusing screen 11 enters the pentagonal prism 21 through the incident end surface 22 thereof to be incident on the roof surface 23a. Subsequently, the light ray incident on the roof surface 23a is reflected thereby toward the other roof surface 23b, and is reflected thereby toward the third reflecting surface 24. Subsequently, the light ray reflected by the roof surface 23b toward the third reflecting surface 24 is reflected by the third reflecting surface 24 toward the exit surface 25, and exits out of the exit surface 25 to be incident on a left eye 41L of the viewer through the eyepiece 31.

A light ray R23c which is incident on the ridge 23c to be reflected thereby is incident on a blind spot 42R of the right eye 41R in the embodiment shown in FIG. 2, and a light ray L23c is incident on a blind spot 42L of the left eye 41L in the embodiment shown in FIG. 3. Therefore, the ridge 23c is hard to be seen by the viewer and is thus unobtrusive when the viewer looks into the eyepiece 31 of the viewfinder shown in FIGS. 2 and 3 by the right eye and the left eye, respectively.

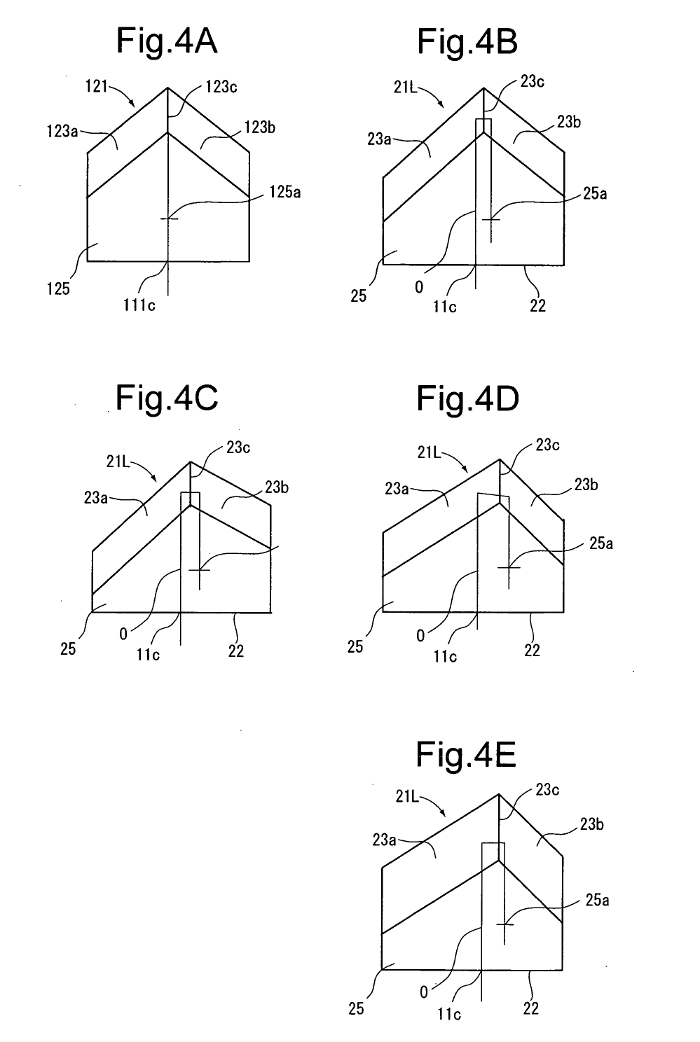

Since the pentagonal prism 21 (21R or 21L) has been shifted in the lengthwise direction (lateral direction) of the focusing screen 11 in each of the first and modified embodiment shown in FIGS. 1, 2 and 3, the entire image formed on the focusing screen 11 may not be visible (only a part of the image may be seen) with the pentagonal prism 21 (21R or 21L) which is a common pentagonal prism having a conventional shape. To overcome this problem, in each of the second through fifth embodiments shown in FIGS. 4B through 4E, respectively, the pentagonal prism 21 is formed so that one of two parts of the incident end surface 22 on the opposite sides with respect to the ridge 23c which is provided at a position shifted in a predetermined direction (rightward as viewed in FIGS. 4B through 4E), is relatively wide compared to the other part of the two parts of the incident end surface 22 which is relatively narrow. The focusing screen 11 and the incident end surface 22 substantially align with each other in the direction of the optical axis O. Namely, the pentagonal prism 21 is formed so that the light of an object image formed on the entire effective area of the focusing screen 11 fully enters the pentagonal prism 21 through the incident end surface 22, is reflected by the roof surfaces 23a and 23b, and the third reflecting surface 24, to exit out of the exit surface 25 to be incident on the eyepiece 31. According to this construction, the pentagonal prism 21 thus formed functions in an equivalent manner to that of the first and modified embodiments due to the ridge 23c being provided at a position which is shifted in the lateral direction, and without having the problem of part of the image formed on the focusing screen 11 not being visible.

FIG. 4A shows a conventional pentagonal prism viewed from the eyepiece 31 side, and FIGS. 4B, 4C, 4D and 4E show the second through fifth embodiments of pentagonal prism 21L, respectively, constructed for the left eye. In the case of the conventional pentagonal prism shown in FIG. 4A, a light ray which travels on the optical axis O that passes through the center 111c of the focusing screen 111 exits out of an exit point 125a on the exit surface 125 via an optical path which lies in a plane including the ridge 123c. In the conventional pentagonal prism shown in FIG. 4A, the ridge 123c lies on a plane orthogonal to the focusing screen 11 passing through the center of the focusing screen 11, and each of the roof surfaces 123a and 123b are provided at a 45 degree angle from this plane.

Unlike the conventional pentagonal prism shown in FIG. 4A, in each of the second through fifth embodiments shown in FIGS. 4B through 4E according to the present invention, a light ray which travels on the optical axis O that passes through the center 11c of the focusing screen 11 is reflected by the roof surface 23a, subsequently reflected by the roof surface 23b forward, and further reflected by the third reflecting surface 24 to exit out of the exit point 25a on the exit surface 25. Namely, the light ray which travels on the optical axis O that passes through the center 11c of the focusing screen 11 is shifted in the lateral direction with respect to the focusing screen 11 by the reflections by the roof prisms 23a and 23b due to the ridge 23c being provided at a position which is shifted in the same lateral direction. In the embodiments shown in FIGS. 4B through 4E, the ridge 23c does not lie on a plane orthogonal to the focusing screen 11 passing through the center of the focusing screen 11.

In the second embodiment shown in FIG. 4B, the roof surface 23a, on which the light ray which travels on the optical axis O that passes through the center 11c of the focusing screen 11 is firstly incident, is elongated in the direction opposite to the lateral direction in which the position of the ridge 23c is shifted, so as to be greater in area than the roof surface 23b, so that the roof surface 23b is shortened in the lateral direction in which the position of the ridge 23c is shifted, so as to be smaller in area than the roof surface 23a, without the angle between the roof surfaces 23a and 23b being changed.

In the third embodiment shown in FIG. 4C, the angle between the roof surfaces 23a and 23b is determined so that the incident angle of the light ray on the roof surface 23a, which travels along the optical axis O that passes through the center 11c of the focusing screen 11 to be incident on the roof surface 23a, is greater than that of the second embodiment shown in FIG. 4B.

In the fourth embodiment shown in FIG. 4D, the angle between the roof surfaces 23a and 23b is determined so that the incident angle of the light ray on the roof surface 23a, which travels along the optical axis O that passes through the center 11c of the focusing screen 11 to be incident on the roof surface 23a, is smaller than that of the second embodiment shown in FIG. 4B.

According to each of the third and fourth embodiments shown in FIGS. 4C and 4D, the volume of the pentagonal prism 21L can be made smaller than the volume of the second embodiment of the pentagonal prism shown in FIG. 4B.

In the fifth embodiment shown in FIG. 4E, the degree of inclination of the ridge 23c is greater than that of the fourth embodiment of the pentagonal prism shown in FIG. 4D.

Although the pentagonal prisms 21L shown in FIGS. 4B through 4E are constructed for the left eye, similar pentagonal prisms (21R) constructed for the right eye can be provided so as to mirror the pentagonal prisms 21L shown in FIGS. 4B through 4E in the lateral direction thereof. Moreover, the present invention can be generally applied to the viewfinder optical system using a pentagonal prism or a pentagonal mirror, though applied to a single-lens reflex camera in the above illustrated embodiment.

Obvious changes may be made in the specific embodiments of the present invention described herein, such modifications being within the spirit and scope of the invention claimed. It is indicated that all matter contained herein is illustrative and does not limit the scope of the present invention.

What is claimed is:

1. A viewfinder comprising:
a focusing screen;
an optical system having a ridge which is formed by cementing a pair of reflecting surfaces to each other; and
an eyepiece,
wherein an object image which is formed on said focusing screen is viewed through said eyepiece via said optical system, and
wherein said ridge is provided at a position in which a line projecting said ridge on said focusing screen is shifted from a central position of said focusing screen so that a light ray which travels on an optical axis passing through a center of said focusing screen is incident on one of said pair of reflecting surfaces and is not incident on said ridge.

2. The viewfinder according to claim 1, wherein said position of said ridge is determined so that said light ray is incident on said one of said pair of reflecting surfaces to be reflected thereby and is subsequently incident on the other of said pair of reflecting surfaces.

3. The viewfinder according to claim 2, wherein a roof portion of said optical system, which includes said pair of reflecting surfaces, is formed so that said one of said pair of reflecting surfaces, on which said light ray is firstly incident, is elongated in said lateral direction to be greater in area than said other of said pair of reflecting surfaces, so that said other of said pair of reflecting surfaces is shortened in said lateral direction to be smaller in area than said one of said pair of reflecting surfaces.

4. The viewfinder according to claim 1, wherein the position of said eyepiece is determined so that a visual axis, of a viewer who views said center of said focusing screen through said eyepiece, does not pass said ridge.

5. The viewfinder according to claim 1, wherein said light ray, which travels on said optical axis that passes through said center of said focusing screen, travels on an optical axis of said eyepiece.

6. The viewfinder according to claim 1, wherein said optical system is formed so that light of said object image which is reflected by said ridge is incident on a blind spot of a viewer who views said object image through said eyepiece.

7. The viewfinder according to claim 1, wherein said viewfinder is incorporated in a single-lens reflex camera.

8. The viewfinder according to claim 1, wherein said optical system is a pentagonal optical element, and wherein said pair of reflecting surfaces are two roof surfaces of said pentagonal optical element.

9. The viewfinder according to claim 8, wherein said pentagonal optical element is one of a pentagonal prism and a hollow pentagonal mirror.

10. A viewfinder comprising:
a focusing screen,
an optical system; and
an eyepiece,
wherein an object image formed on said focusing screen is viewed through said optical system and said eyepiece,
wherein said optical system is positioned relative to said focusing screen so that a center of said focusing screen and a ridge between a pair of reflecting surfaces of said optical system do not lie in a common plane orthogonal to a plane in which said focusing screen lies.
